(19) United States
(12) Patent Application Publication
(10) Pub. No.: US 2026/0213456 A1
(43) Pub. Date: Jul. 23, 2026

(54) BOARD-END CONNECTOR

(71) Applicant: BIZLINK INTERNATIONAL CORP., New Taipei City (TW)

(72) Inventors: Yunyu LIU, New Taipei City (TW); Hsin-Hung HSU, New Taipei City (TW)

(21) Appl. No.: 19/034,571

(22) Filed: Jan. 23, 2025

(51) Int. Cl. H01R 13/518; H01R 13/424

(52) U.S. Cl. CPC H01R 13/518; H01R 13/424

(57) ABSTRACT

A board-end connector includes a terminal holder, a first frame, and a second frame. The terminal holder has a first side surface and a second side surface opposite to each other, a first groove on the first side surface, and a second groove on the second side surface. The first frame and the second frame are respectively disposed on two opposite sides of the terminal holder. The first frame and the second frame are fixed to the terminal holder. Each of the first frame and the second frame includes a first bending portion embedded in the first groove and a second bending portion embedded in the second groove. The first bending portion and the second bending portion are located on both ends of each of the first frame and the second frame.

### BACKGROUND

### Field of Invention

The present invention relates to a board-end connector.

### Description of Related Art

Generally, a board-end connector includes a terminal holder accommodating conductive terminals and a frame surrounding the terminal holder. The frame is usually formed in one piece. However, the tolerance of the one-piece frame cannot be compensated through subsequent adjustments during assembling due to high cost of the process and strict requirement of the tolerance.

How to propose a board-end connector that can solve the aforementioned problems is one of the problems that the industry is currently eager to invest in research and development resources to solve.

### SUMMARY

In view of this, one purpose of the present disclosure is to provide a board-end connector that can solve the aforementioned problems.

In order to achieve the above objective, according to an embodiment of the present disclosure, a board-end connector includes a terminal holder, a first frame, and a second frame. The terminal holder has a first side surface and a second side surface opposite to each other, a first groove on the first side surface, and a second groove on the second side surface. The first frame and the second frame are respectively disposed on two opposite sides of the terminal holder. The first frame and the second frame are fixed to the terminal holder. Each of the first frame and the second frame includes a first bending portion embedded in the first groove and a second bending portion embedded in the second groove. The first bending portion and the second bending portion are located on both ends of each of the first frame and the second frame. The first frame and the second frame form an accommodating space to accommodate the terminal holder.

### BRIEF DESCRIPTION OF THE DRAWINGS

The invention can be more fully understood by reading the following detailed description of the embodiment, with reference made to the accompanying drawings as follows:

FIG. 1 is a perspective view of a board-end connector in accordance with an embodiment of the present disclosure;

FIG. 2 is a top view of the board-end connector in accordance with an embodiment of the present disclosure;

FIG. 3 is a top view of the board-end connector in accordance with another embodiment of the present disclosure;

FIG. 4 is a partial top view of the board-end connector in accordance with an embodiment of the present disclosure;

FIG. 5 is a partial top view of the board-end connector in accordance with an embodiment of the present disclosure;

FIG. 6 is a sided view of the board-end connector in accordance with an embodiment of the present disclosure;

FIG. 7 is a sided view of the board-end connector in accordance with another embodiment of the present disclosure;

FIG. 8 is a cross-sectional view of the board-end connector based on a section A-A′ of FIG. 2 in accordance with an embodiment of the present disclosure; and

FIG. 9 is a cross-sectional view of the board-end connector based on a section B-B′ of FIG. 2 in accordance with an embodiment of the present disclosure.

### DETAILED DESCRIPTION

Hereinafter, a plurality of embodiments of the present disclosure will be disclosed in diagrams. For the sake of clarity, many details in practice will be described in the following description. However, it should be understood that these details in practice should not limit present disclosure. In other words, in some embodiments of present disclosure, these details in practice are unnecessary. In addition, for simplicity of the drawings, some conventionally used structures and elements will be shown in a simple schematic manner in the drawings. The same reference numbers are used in the drawings and the description to refer to the same or like parts.

Hereinafter, the structure and function of each component included in the board-end connector 100 of this embodiment and the connection relationship between the components will be described in detail.

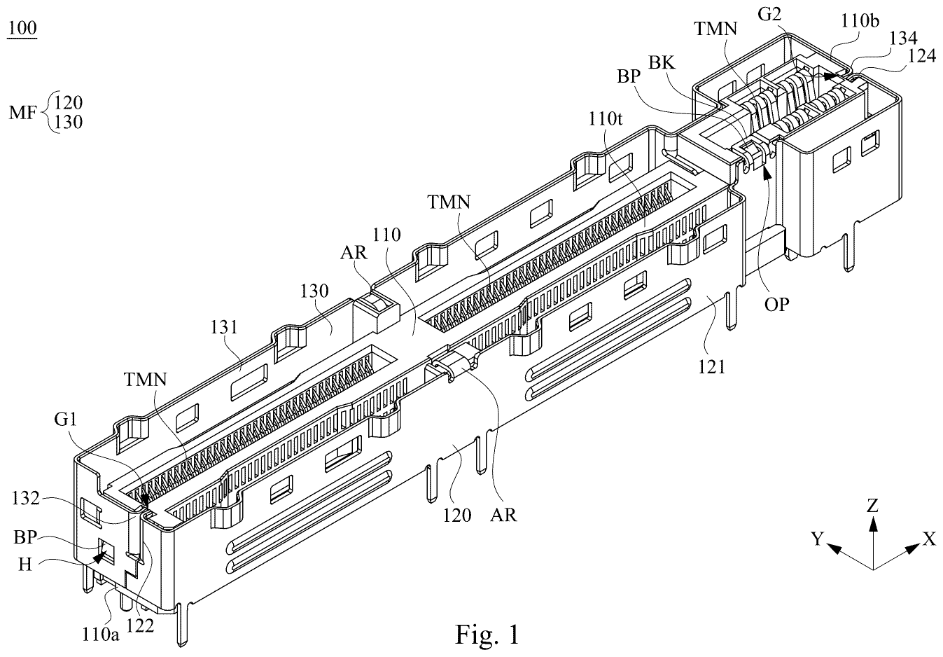

Reference is made to FIG. 1. FIG. 1 is a perspective view of a board-end connector 100 in accordance with an embodiment of the present disclosure. As shown in FIG. 1, in this embodiment, the board-end connector 100 includes a terminal holder 110 and a metal frame set MF. The terminal holder 110 is embedded with a plurality of conductive terminals TMN. Specifically, the terminal holder 110 is configured to secure the conductive terminals TMN. The terminal holder 110 has a first side surface 110a and a second side surface 110b. The first side surface 110a and the second side surface 110b are opposite to each other and arranged in a direction (e.g. x-direction). The terminal holder 110 further includes a bump BP on the first side surface 110a. The bump BP and groove G1 are designed to secure and align the terminal holder 110 with the frames. The terminal holder 110 further has a first groove G1 on the first side surface 110a and a second groove G2 on the second side surface 110b. The first groove G1 and the second groove G2 are elongated in a direction (e.g., z-direction). The first groove G1 is separated from the bump BP.

Reference is made again to FIG. 1. As shown in FIG. 1, in this embodiment, the metal frame set MF includes a first frame 120 and a second frame 130. The first frame 120 and the second frame 130 are respectively disposed on two opposite sides of the terminal holder 110 and fixed to the terminal holder 110. The first frame 120 includes a main body 121, a first bending portion 122, and a second bending portion 124. The first bending portion 122 and the second bending portion 124 are located on both ends of the first frame 120. Specifically, the first bending portion 122 and the second bending portion 124 are located on both ends of the main body 121. The first bending portion 122 and the second bending portion 124 are respectively bent from the both ends of the main body 121. The first bending portion 122 is embedded in the first groove G1 and the second bending portion 124 is embedded in the second groove G2. In some embodiments, the first frame 120 further includes a blocking arm AR disposed on a top of the main body 121. As the first frame 120 is installed downward to the terminal holder 110, the blocking arm AR interferes with the top surface 110t of the terminal holder 110, so that the first frame 120 is positioned on the terminal holder 110.

As shown in FIG. 1, in some embodiments, the terminal holder 110 further includes another bump BP disposed on a top surface 110t of the terminal holder 110, and the first frame 120 further includes a buckling portion BK extending from the main body 121. The main body 121 and the buckling portion BK jointly define an opening OP encircling the bump BP on the top surface 110t of the terminal holder 110. The buckling portion BK of the first frame 120 is engaged with the bump BP on the top surface 110t of the terminal holder 110.

Reference is made again to FIG. 1. As shown in FIG. 1, in this embodiment, the second frame 130 includes a main body 131, a first bending portion 132, and a second bending portion 134. The first bending portion 132 and the second bending portion 134 are located on both ends of the second frame 130. Specifically, the first bending portion 132 and the second bending portion 134 are located on both ends of the main body 131. The first bending portion 132 and the second bending portion 134 are respectively bent from the both ends of the main body 131. The first bending portion 132 is embedded in the first groove G1 and the second bending portion 134 is embedded in the second groove G2. In some embodiments, the second frame 130 further includes a blocking arm AR disposed on a top of the main body 131. As the second frame 130 is installed downward to the terminal holder 110, the blocking arm AR interferes with the top surface 110t of the terminal holder 110, so that the second frame 130 is positioned on the terminal holder 110. The second frame 130 further has a hole H. The hole H is disposed corresponding to the bump BP on the first side surface 110a. The bump BP on the first side surface 110a is engaged with the hole H.

In some embodiments, each of the first frame 120 and the second frame 130 is a bent metal plate. Specifically, each of the first frame 120 and the second frame 130 is integrally formed in one piece.

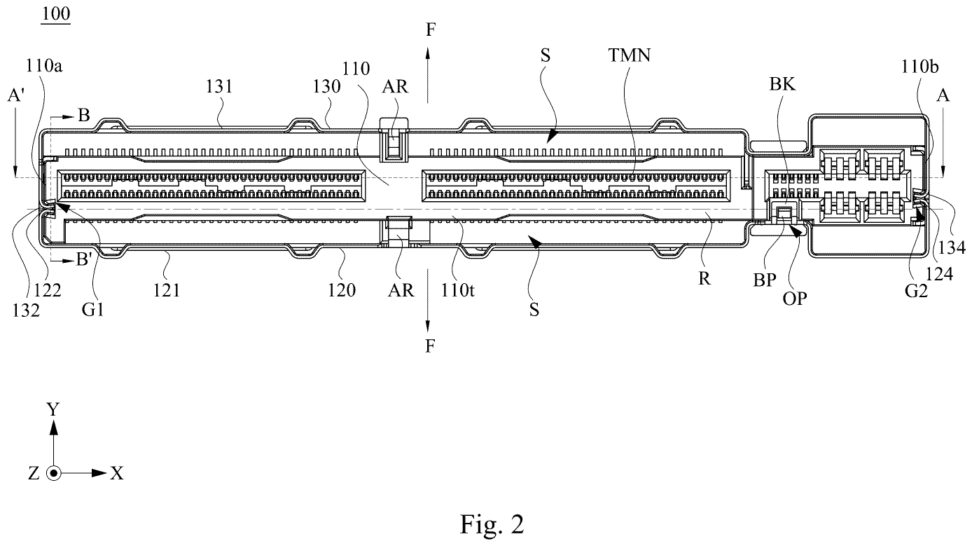

Reference is made to FIG. 2. FIG. 2 is a top view of the board-end connector 100 in accordance with an embodiment of the present disclosure. As shown in FIG. 2, in this embodiment, the first groove G1 is recessed from the first side surface 110a and the second groove G2 is recessed from the second side surface 110b. The first frame 120 and the second frame 130 form an accommodating space S. The accommodating space S is configured to accommodate the terminal holder 110. As shown in FIG. 2, the groove G1 is not aligned with the groove G2 along a direction (e.g., x-direction). Specifically, a reference line R is depicted in FIG. 2. The reference line R is extended in a direction (e.g., x-direction). The reference line R crosses between the first bending portion 122 of the first frame 120 and the first bending portion 132 of the second frame 130 but does not cross between the second bending portion 124 of the first frame 120 and the second bending portion 134 of the second frame 130.

In a usage scenario, the first frame 120 and the second frame 130 may deform by applying a pulling force F away from the terminal holder 110. The first bending portion 122 and the first bending portion 132 are embedded in the groove G1, and the second bending portion 124 and the second bending portion 134 are embedded in the groove G2, so the first frame 120 and the second frame 130 will not be detached from the terminal holder 110.

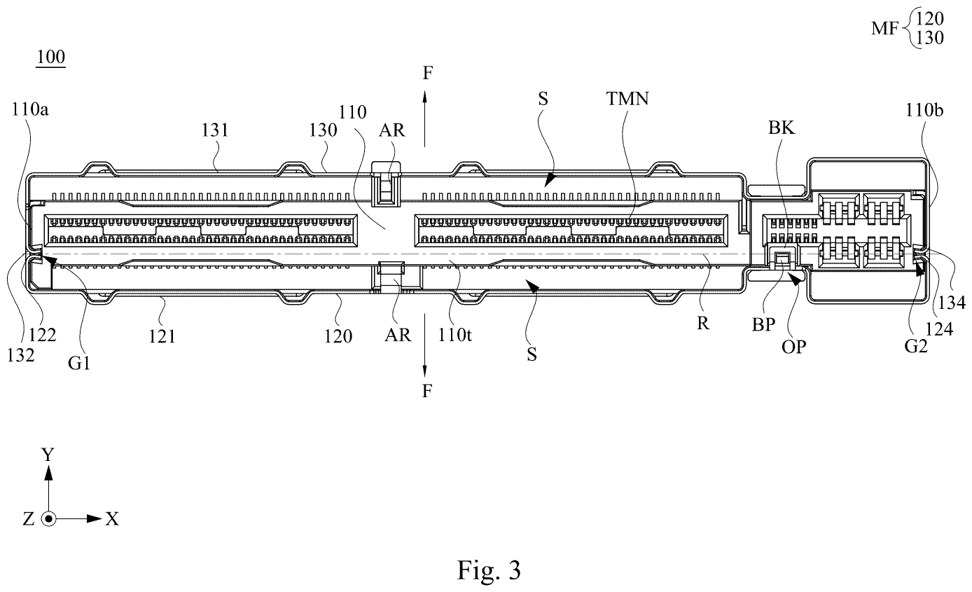

Reference is made to FIG. 3. FIG. 3 is a top view of the board-end connector 100 in accordance with another embodiment of the present disclosure. The structural configuration of the board-end connector 100 of FIG. 3 is similar to the structural configuration of the board-end connector 100 of FIG. 2. The difference in between is that the reference line R not only crosses between the first bending portion 122 of the first frame 120 and the first bending portion 132 of the second frame 130, but also crosses between the second bending portion 124 of the first frame 120 and the second bending portion 134 of the second frame 130, as shown in FIG. 3.

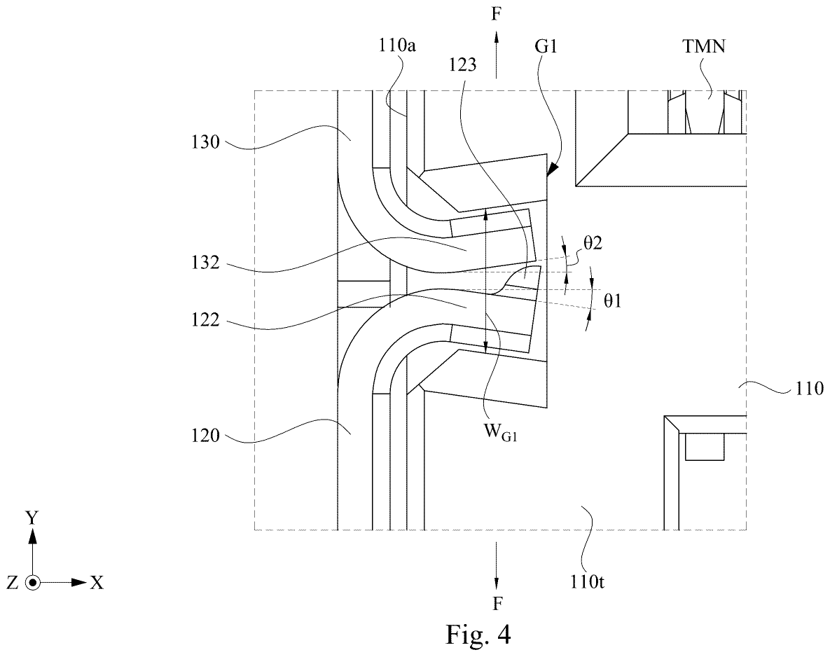

Reference is made to FIG. 4. FIG. 4 is a partial top view of the board-end connector 100 in accordance with an embodiment of the present disclosure. As shown in FIG. 4, in this embodiment, the first bending portion 122 of the first frame 120 and the first bending portion 132 of the second frame 130 buckle the terminal holder 110 on the first side surface 110a. The first frame 120 further includes a first convex portion 123 disposed on the first bending portion 122 of the first frame 120. In some embodiments, the first convex portion 123 is disposed on the first bending portion 132 of the second frame 130. The first convex portion 123 is located between the first bending portion 122 of the first frame 120 and the first bending portion 132 of the second frame 130. The first bending portion 122 and the first bending portion 132 extend in a direction inclined relative to the first side surface 110a. Specifically, a first angle θ1 is between an extending direction of the first bending portion 122 and a direction normal to the first side surface 110a (e.g., x-direction). A second angle θ2 is between an extending direction of the first bending portion 132 and the direction normal to the first side surface 110a (e.g., x-direction). In some embodiments, the first angle θ1 and the second angle θ2 are about 8 degrees, and are preferably in a range of 6 to 10 degrees. The first bending portion 122 of the first frame 120 and the first b1ending portion 132 of the second frame 130 extend away from each other along a depth direction of the first groove G1 (i.e., toward positive x-direction).

As shown in FIG. 4, in some embodiments, the first groove G1 has a width W_{G1} parallel to the first side surface 110a (i.e., parallel to y-direction). The width W_{G1} of the first groove G1 tapers outward. Specifically, the width W_{G1} is shallower in an outer side of the first groove G1 and is wider in an inner side of the first groove G1.

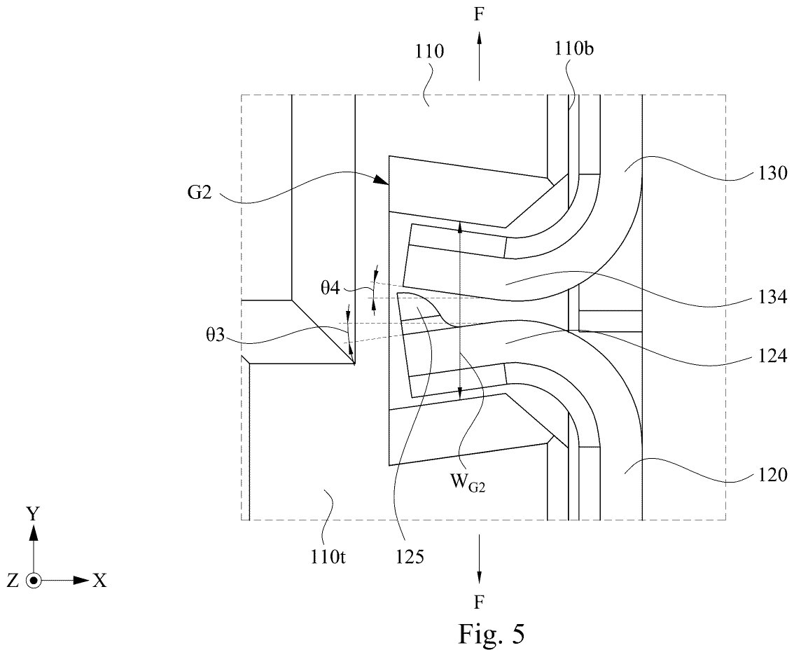

Reference is made to FIG. 5. FIG. 5 is a partial top view of the board-end connector 100 in accordance with an embodiment of the present disclosure. As shown in FIG. 5, in this embodiment, the second bending portion 124 of the first frame 120 and the second bending portion 134 of the second frame 130 buckle the terminal holder 110 on the second side surface 110b. The first frame 120 further includes a second convex portion 125 disposed on the second bending portion 124 of the first frame 120. In some embodiments, the second convex portion 125 is disposed on the second bending portion 134 of the second frame 130. The second convex portion 125 is located between the second bending portion 124 of the first frame 120 and the second bending portion 134 of the second frame 130. The second bending portion 124 and the second bending portion 134 extend in a direction inclined relative to the second side surface 110b. Specifically, a third angle θ3 is between an extending direction of the second bending portion 124 and a direction normal to the second side surface 110b (e.g., x-direction). A fourth angle θ4 is between an extending direction of the second bending portion 134 and the direction normal to the second side surface 110b (e.g., x-direction). In some embodiments, the third angle θ3 and the fourth angle θ4 are about 8 degrees, and are preferably in a range of 6 to 10 degrees.

The second bending portion 124 of the first frame 120 and the second bending portion 134 of the second frame 130 extend away from each other along a depth direction of the second groove G2 (i.e., toward negative x-direction).

As shown in FIG. 5, in some embodiments, the second groove G2 has a width W_{G2} parallel to the second side surface 110b (i.e., parallel to y-direction). The width W_{G2} of the second groove G2 tapers outward. Specifically, the width W_{G2} is shallower in an outer side of the second groove G2 and is wider in an inner side of the second groove G2.

In a usage scenario, since the board-end connector 100 includes the first convex portion 123 and the second convex portion 125, the first convex portion 123 and the second convex portion 125 respectively abut against to the first bending portion 132 and the second bending portion 134 as the first frame 120 and the second frame 130 are applied with the pulling force F, so as to avoid the first frame 120 and the second frame 130 detached from the terminal holder 110.

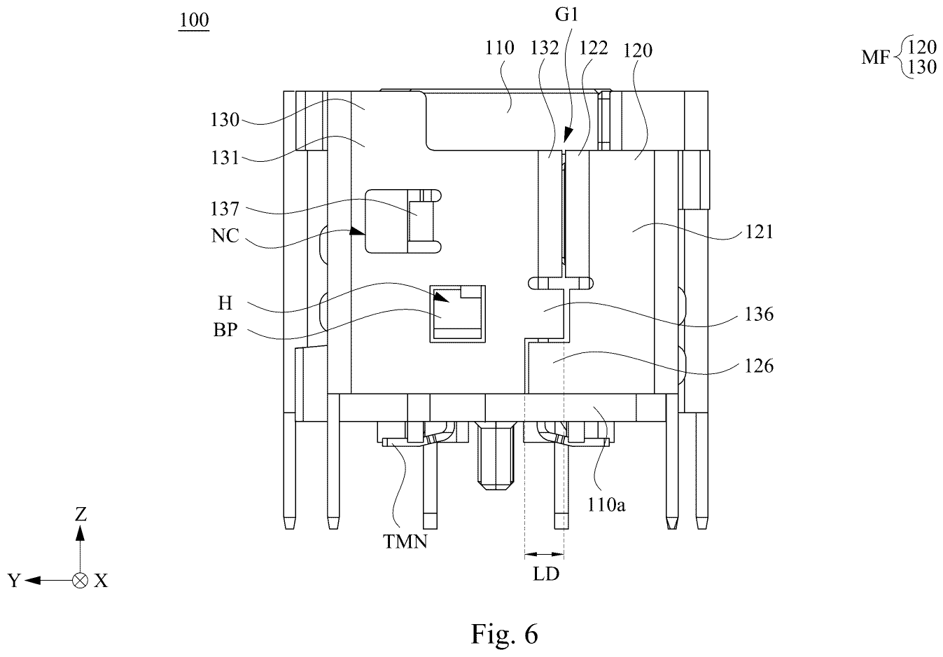

Reference is made to FIG. 6. FIG. 6 is a sided view of the board-end connector 100 in accordance with an embodiment of the present disclosure. As shown in FIG. 6, in this embodiment, the first frame 120 further includes a lower extending portion 126 located at an end of the main body 121 of the first frame 120. The lower extending portion 126 and the first bending portion 122 are located in the same side of the main body 121. The second frame 130 further includes an upper extending portion 136 located at an end of the main body 131 of the second frame 130. The upper extending portion 136 and the first bending portion 132 are located in the same side of the main body 131. The upper extending portion 136 is located over the lower extending portion 126. The lower extending portion 126 and the upper extending portion 136 are located below the first groove G1. A step LD exists between the upper extending portion 136 and the main body 131. The step LD is approximately equal to a length that the lower extending portion 126 protruding from the main body 121. In a usage scenario, the user installs the first frame 120 on the terminal holder 110, and then installs the second frame 130 on the terminal holder 110, such that the upper extending portion 136 can block the lower extending portion 126, thereby preventing the first frame 120 from moving along a direction (e.g., z-direction).

Reference is made again to FIG. 6. As shown in FIG. 6, the second frame 130 further includes a fastening portion 137 and has a notch NC. The fastening portion 137 is extended and bent from the main body 131, and the fastening portion 137 protrudes from an edge of the notch NC. The notch NC is separated from the hole H.

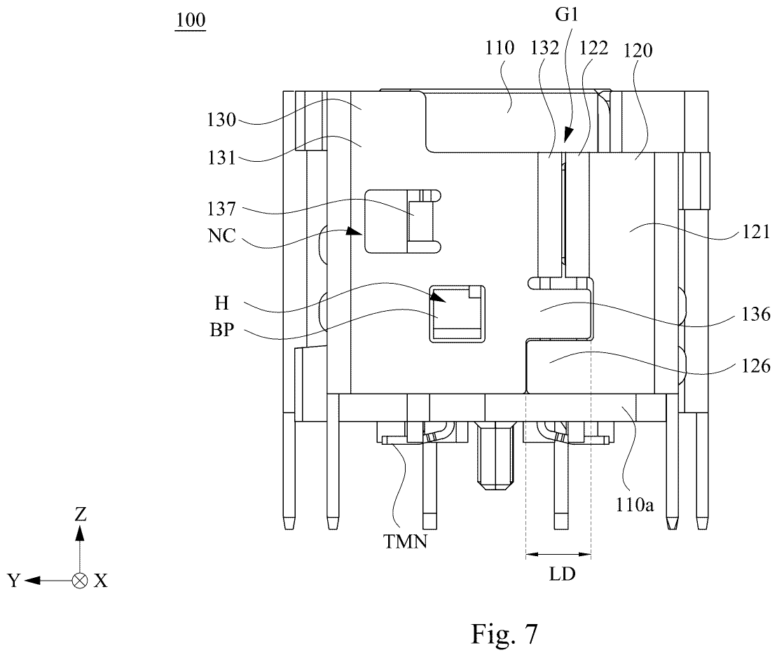

Reference is made to FIG. 7. FIG. 7 is a sided view of the board-end connector 100 in accordance with another embodiment of the present disclosure. The structural configurations of the first frame 120 and the second frame 130 of FIG. 6 and the structural configurations of the first frame 120 and the second frame 130 of FIG. 7 are similar. The difference in between is that the step LD in FIG. 7 transverses under the first bending portion 122 and the first bending portion 132, whereas the step LD in FIG. 6 merely transverses under the first bending portion 132.

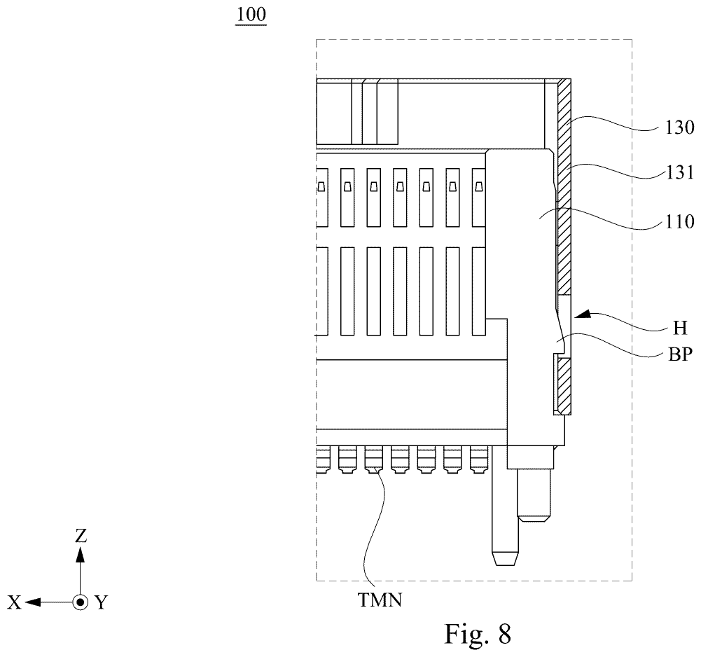

Reference is made to FIG. 8. FIG. 8 is a cross-sectional view of the board-end connector 100 based on the section A-A′ of FIG. 2 in accordance with an embodiment of the present disclosure. As shown in FIG. 8, in this embodiment, the bump BP is engaged with the hole H, and the bump BP is accommodated in the hole H. Specifically, the bump BP has a slant connected to the first side surface 110a, as shown in FIG. 6 and FIG. 8. In a usage scenario, as the second frame 130 is installed downward to the terminal holder 110, a portion of the main body 131 beneath the hole H moves along the slant of the bump BP and slightly deforms relative to a portion of the main body 131 above the hole H. Next, as the portion of the main body 131 beneath the hole H moves until it is under the hole H, the bump BP passes through the hole H and the portion of the main body 131 beneath the hole H elastically recovers, as shown in FIG. 8.

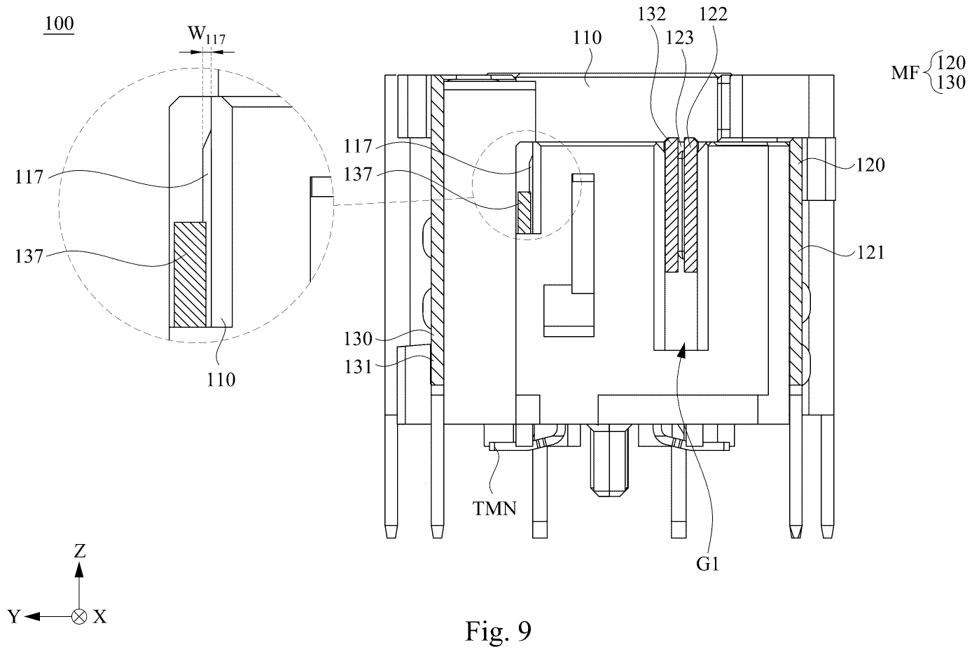

Reference is made to FIG. 9. FIG. 9 is a cross-sectional view of the board-end connector 100 based on the section B-B′ of FIG. 2 in accordance with an embodiment of the present disclosure. As shown in FIG. 9, in this embodiment, the board-end connector 100 further includes a convex bar 117 disposed on the terminal holder 110. The convex bar 117 is disposed corresponding to the fastening portion 137. The convex bar 117 is elongated in a direction (e.g., z-direction). The convex bar 117 has a width W₁₁₇ parallel to a direction (e.g., y-direction). In some embodiments, the width W₁₁₇ of the convex bar 117 tapers upward. Specifically, the width W₁₁₇ is shallower on a top of the convex bar 117 and is wider on a bottom of the convex bar 117. In some embodiments, the convex bar 117 has a slant on the top of the convex bar 117. In a usage scenario, as the second frame 130 is installed downward to the terminal holder 110, the fastening portion 137 moves along the slant of the convex bar 117 and slightly deforms relative to the main body 131. Next, as the fastening portion 137 continues to move downward, the fastening portion 137 encircles and tightly bounds a portion of the convex bar 117 with a wider width W₁₁₇, as shown in FIG. 8.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A board-end connector comprising:
a terminal holder configured to secure a plurality of conductive terminals, having a first side surface and a second side surface opposite to each other, a first groove on the first side surface, and a second groove on the second side surface; and
a first frame and a second frame respectively disposed on two opposite sides of the terminal holder and fixed to the terminal holder, wherein each of the first frame and the second frame comprises a first bending portion embedded in the first groove and a second bending portion embedded in the second groove,
wherein the first bending portion and the second bending portion are located on both ends of each of the first frame and the second frame,
wherein the first frame and the second frame form an accommodating space to accommodate the terminal holder.

2. The board-end connector of claim 1, wherein the first bending portion of the first frame and the first bending portion of the second frame buckle the terminal holder on the first side surface, and the second bending portion of the first frame and the second bending portion of the second frame buckle the terminal holder on the second side surface.

3. The board-end connector of claim 1, wherein a width of the first groove parallel to the first side surface and a width of the second groove parallel to the second side surface taper outward.

4. The board-end connector of claim 1, wherein the first bending portion of the first frame and the first bending portion of the second frame extend away from each other along a depth direction of the first groove, and the second bending portion of the first frame and the second bending portion of the second frame extend away from each other along a depth direction of the second groove.

5. The board-end connector of claim 1, further comprising a first convex portion and a second convex portion respectively disposed on the first bending portion and the second bending portion of one of the first frame and the second frame.

6. The board-end connector of claim 5, wherein the first convex portion is located between the first bending portion of the first frame and the first bending portion of the second frame, and the second convex portion is located between the second bending portion of the first frame and the second bending portion of the second frame.

7. The board-end connector of claim 1, wherein the first bending portion extends in a direction inclined relative to the first side surface, and the second bending portion extends in a direction inclined relative to the second side surface.

8. The board-end connector of claim 1, wherein the first frame further comprises a lower extending portion at an end of the first frame and extending toward the second frame, and the second frame further comprises an upper extending portion at an end of the second frame and extending toward the first frame, and wherein the upper extending portion is located over the lower extending portion.

9. The board-end connector of claim 8, wherein the lower extending portion and the upper extending portion are located below the first groove.

10. The board-end connector of claim 1, wherein the terminal holder further comprises a bump on the first side surface, and the second frame further has a hole corresponding to the bump, and wherein the bump is engaged with the hole.

11. A board-end connector comprising:
a terminal holder configured to secure a plurality of conductive terminals, having a first side surface and a second side surface opposite to each other, a first groove on the first side surface, and a second groove on the second side surface; and
a first frame and a second frame respectively disposed on two opposite sides of the terminal holder and fixed to the terminal holder, wherein each of the first frame and the second frame comprises a first bending portion embedded in the first groove and a second bending portion embedded in the second groove,
wherein the first bending portion and the second bending portion are located on both ends of each of the first frame and the second frame,
wherein each of the first frame and the second frame is a bent metal plate.

12. The board-end connector of claim 11, wherein the first bending portion of the first frame and the first bending portion of the second frame buckle the terminal holder on the first side surface, and the second bending portion of the first frame and the second bending portion of the second frame buckle the terminal holder on the second side surface.

13. The board-end connector of claim 11, wherein a width of the first groove parallel to the first side surface and a width of the second groove parallel to the second side surface taper outward.

14. The board-end connector of claim 11, wherein the first bending portion of the first frame and the first bending portion of the second frame extend away from each other along a depth direction of the first groove, and the second bending portion of the first frame and the second bending portion of the second frame extend away from each other along a depth direction of the second groove.

15. The board-end connector of claim 11, further comprising a first convex portion and a second convex portion respectively disposed on the first bending portion and the second bending portion of one of the first frame and the second frame.

16. The board-end connector of claim 15, wherein the first convex portion is located between the first bending portion of the first frame and the first bending portion of the second frame, and the second convex portion is located between the second bending portion of the first frame and the second bending portion of the second frame.

17. The board-end connector of claim 11, wherein the first bending portion extends in a direction inclined relative to the first side surface, and the second bending portion extends in a direction inclined relative to the second side surface.

18. The board-end connector of claim 11, wherein the first frame further comprises a lower extending portion at an end of the first frame and extending toward the second frame, and the second frame further comprises an upper extending portion at an end of the second frame and extending toward the first frame, and wherein the upper extending portion is located over the lower extending portion.

19. The board-end connector of claim 18, the lower extending portion and the upper extending portion are located below the first groove.

20. The board-end connector of claim 11, wherein the terminal holder further comprises a bump on the first side surface, and the second frame further has a hole corresponding to the bump, and wherein the bump is engaged with the hole.
